(19) United States
(12) Patent Application Publication
(10) Pub. No.: US 2022/0028119 A1
(43) Pub. Date: Jan. 27, 2022

(54) METHOD, DEVICE, AND COMPUTER-READABLE RECORDING MEDIUM FOR COMPRESSING 3D MESH CONTENT

(71) Applicant: Samsung Electronics Co., Ltd., Suwon-si, Gyeonggi-do (KR)

(72) Inventors: Sungryeul RHYU, Suwon-si (KR); Youngho OH, Suwon-si (KR); Jihwan WOO, Suwon-si (KR)

(21) Appl. No.: 17/413,105

(22) PCT Filed: Dec. 13, 2019
(86) PCT No.: PCT/KR2019/017726

§ 371 Date: Jun. 11, 2021

(30) Foreign Application Priority Data
Dec. 13, 2018 (KR) 10-2018-0161183

(51) Int. Cl. G06T 9/00

(52) U.S. Cl. CPC G06T 9/001

(57) ABSTRACT

Provided is a method of compressing mesh content representing a 3-dimensional (3D) object, the mesh content including vertex information about a plurality of vertexes of the 3D object, a face command about a face formed by connecting the vertexes, and texture information about a color of the face, the method including: obtaining a scale factor and generating a plurality of scaled vertexes by changing an interval between the vertexes, generating a mesh point cloud by padding a space between the scaled vertexes with points, obtaining a geometry image from the mesh point cloud, obtaining a texture image based on the texture information, displaying the scaled vertexes on an occupancy map, translating the face command based on at least one of the scale factor or the occupancy map, and generating a bitstream by compressing the geometry image, the texture image, the occupancy map, and the translated face command with a video based point cloud compression (V-PCC) encoder.

### TECHNICAL FIELD

The disclosure relates to a method and device for processing 3-dimensional (3D) video data.

### BACKGROUND ART

A point cloud, which is a method of representing 3-dimensional (3D) data, refers to a group of a massive amount of points, and a massive amount of 3D data that can be represented as a point cloud. That is, a point cloud refers to samples extracted in a process of obtaining a 3D model.

A point cloud is a value that can be compared with a 2-dimensional (2D) image, and also is a method of representing a point in a 3D space. A point cloud has a vector form that can include both location coordinates and colors. For example, a point cloud can be represented as (x, y, z, R, G, B). A point cloud forming a spatial configuration by collecting numerous colors and location data converges on more specific data as the density thereof is higher, thereby having significance as a 3D model.

With regard to various embodiments of the disclosure, video-based point cloud compression (V-PCC) discussed in the moving picture experts group (MPEG) can be used as background technology.

### DESCRIPTION OF EMBODIMENTS

### Technical Problem

Video-based point cloud compression (V-PCC) is a dynamic point cloud coding technology for objects representing 3-dimensional (3D) images, and the V-PCC uses a method of scaling point cloud data into a 2-dimensional (2D) video sequence to compress the 2D video sequence via an existing codec such as high efficiency video coding (HEVC). A V-PCC encoder may create various representation information as metadata, in addition to video sequences, additionally include the metadata in a bitstream, and transmit the bitstream, and a decoder may reconstruct point cloud data by using the representation information.

A dynamic point cloud coding structure may be a structure of projecting each face of a point cloud onto a 2D plane for each frame to generate a map of distance information and patch information consisting of several pieces, and of compressing the map with a video encoder.

In compressing mesh content by using V-PCC, vertexes included in the mesh content may correspond to points of a point cloud. However, in the case of mesh content, spaces between vertexes are padded with triangular planes, whereas, in point cloud data, spaces between points are padded with points. Accordingly, a density of vertexes included in mesh content is different from that of points included in point cloud data.

Therefore, when V-PCC is applied to mesh content without performing separate processing, most of vertexes are considered as missed points and processed, instead of being processed as points, during V-PCC, and accordingly, there is a problem in that no compression effect is obtained.

### Solution to Problem

The disclosure provides a method and device for scaling mesh content representing a 3-dimensional (3D) object into a video-based point cloud compression (V-PCC) compressible form to compress the mesh content.

Meanwhile, according to an embodiment of the disclosure, a computer-readable recording medium having recorded thereon a program for executing the above-described method is provided.

Also, other methods and systems for implementing the disclosure and a computer-readable recording medium having recorded thereon a computer program for executing the methods are further provided.

### Advantageous Effects of Disclosure

According to the disclosure, mesh content may be effectively scaled to be compressed by using video-based point cloud compression (V-PCC). Also, according to the disclosure, key architecture of V-PCC may be used, and the quality of compression ranging from lossless to loss may be set, as necessary.

### BRIEF DESCRIPTION OF DRAWINGS

FIG. 1A illustrates a general data process of a transmitter for transmitting data about a 3-dimensional (3D) image, according to an embodiment of the disclosure.

FIG. 1B illustrates a structure of a video-based point cloud compression (V-PCC) encoder.

FIG. 2A illustrates a general data process of a receiver for receiving data about a 3D image, according to an embodiment of the disclosure.

FIG. 2B illustrates a structure of a V-PCC decoder.

FIG. 3 is a flowchart illustrating a method of compressing mesh content by using V-PCC, according to an embodiment of the disclosure.

FIG. 4 is a view for describing a process of obtaining a scaled vertex and a scale factor, according to an embodiment of the disclosure.

FIG. 5 is a view for describing a vertex scaling process according to an embodiment of the disclosure.

FIG. 6 is a view for describing a process of transforming scaled vertexes to a mesh point cloud for V-PCC.

FIG. 7 is a view for describing a process of transforming mesh content to a mesh point cloud by using scaled vertex information of the mesh content, according to an embodiment of the disclosure.

FIG. 8 is a view for describing a process of padding points by quantizing mesh content representing a 3D object, according to an embodiment of the disclosure.

FIG. 9 is a view for describing a process of displaying scaled vertexes of mesh content on an occupancy map, according to an embodiment of the disclosure.

FIG. 10 illustrates an occupancy map displaying points for 2-dimensional (2D) patches of mesh point cloud data, according to an embodiment of the disclosure.

FIG. 11 is a view for describing a process of representing face commands about vertexes based on a bitmap of an occupancy map, according to an embodiment of the disclosure.

FIG. 12 illustrates architecture of a device of compressing mesh content by using V-PCC, according to an embodiment of the disclosure.

FIG. 13 is a block diagram of a device of compressing mesh content, according to an embodiment of the disclosure.

### BEST MODE

Representative configurations of the disclosure for accomplishing the above-described objectives are as follows.

To overcome the above-described technical problem, there is provided a method of compressing mesh content representing a 3-dimensional (3D) object, according to an embodiment of the disclosure, the mesh content including vertex information about a plurality of vertexes of the 3D object, a face command about a face formed by connecting the vertexes, and texture information about a color of the face, the method including: obtaining a scale factor and generating a plurality of scaled vertexes by changing an interval between the vertexes; generating a mesh point cloud by padding a space between the scaled vertexes with points; obtaining a geometry image from the mesh point cloud; obtaining a texture image based on the texture information; displaying the scaled vertexes on an occupancy map; translating the face command based on at least one of the scale factor or the occupancy map; and generating a bitstream by compressing the geometry image, the texture image, the occupancy map, and the translated face command with a video based point cloud compression (V-PCC) encoder.

### MODE OF DISCLOSURE

Hereinafter, embodiments of the disclosure will be described in detail with reference to the accompanying drawings.

When the embodiments are described, descriptions about technical content well known in the technical field to which the disclosure belongs and not directly related to the disclosure will be omitted. The reason for this is to more clearly convey, without obscuring, the gist of the disclosure by omitting unnecessary descriptions.

For the same reason, some components of the accompanying drawings may be exaggeratedly shown, omitted, or schematically shown. Also, the sizes of the components do not completely reflect their actual sizes. The same or corresponding components in the drawings are assigned like reference numerals.

Advantages and features of the disclosure and a method for achieving them will be clear with reference to the accompanying drawings, in which embodiments are shown. The disclosure may, however, be embodied in many different forms and should not be construed as being limited to the embodiments set forth herein; rather, these embodiments are provided so that this disclosure will be thorough and complete, and will fully convey the concept of the disclosure to those of ordinary skill in the art, and the disclosure is only defined by the scope of the claims. Like reference numerals denote like elements throughout the specification.

It will be appreciated that the combinations of blocks and flowchart illustrations in the process flow diagrams may be performed by computer program instructions. These computer program instructions may be loaded into a processor of a general purpose computer, a special purpose computer, or other programmable data processing equipment, so that those instructions, which are executed through a processor of a computer or other programmable data processing equipment, create means for performing functions described in the flowchart block(s). These computer program instructions may also be stored in a computer usable or computer readable memory capable of directing a computer or other programmable data processing equipment to implement the functions in a particular manner so that the instructions stored in the computer usable or computer readable memory are also capable of producing manufacturing items containing instruction means for performing the functions described in the flowchart block(s). Computer program instructions may also be installed on a computer or other programmable data processing equipment so that a series of operating steps may be performed on a computer or other programmable data processing equipment to create a computer-executable process. Therefore, it is also possible for the instructions to operate the computer or other programmable data processing equipment to provide steps for executing the functions described in the flowchart block(s).

In addition, each block may represent a module, segment, or portion of code that includes one or more executable instructions for executing specified logical function(s). It should also be noted that in some alternative implementations, the functions mentioned in the blocks may occur out of order. For example, two blocks shown in succession may actually be executed substantially concurrently, or the blocks may sometimes be performed in reverse order according to the corresponding function.

As used herein, the terms ‘portion’, ‘module’, or ‘unit’ refers to a unit that can perform at least one function or operation, and may be implemented as a software or hardware component such as a Field Programmable Gate Array (FPGA) or an Application Specific Integrated Circuit (ASIC). However, the term ‘portion’, ‘module’ or ‘unit’ is not limited to software or hardware. The ‘portion’, ‘module’, or ‘unit’ may be configured in an addressable storage medium, or may be configured to run on at least one processor. Therefore, according to an embodiment of the disclosure, the ‘portion’, ‘module’, or ‘unit’ includes: components such as software components, object-oriented software components, class components, and task components; processes, functions, attributes, procedures, sub-routines, segments of program codes, drivers, firmware, microcodes, circuits, data, databases, data structures, tables, arrays, and variables. Functions provided in the components and ‘portions’, ‘modules’ or ‘units’ may be combined into a smaller number of components and ‘portions’, ‘modules’ and ‘units’, or sub-divided into additional components and ‘portions’, ‘modules’ or ‘units’. Also, the components and ‘portions’, ‘modules’ or ‘units’ may be configured to run on one or more central processing units (CPUs) in a device or a security multimedia card. Also, in the embodiments, the ‘portion’, ‘module’ or ‘unit’ may include one or more processors.

In the present specification, an “image” may include a still image, a moving image, a video frame, and/or a video stream, and may include a 2-dimensional (2D) frame and a 3-dimensional (3D) frame. For example, an “image” may include a 3D frame or a 360 degree omnidirectional media frame, which is represented as a point cloud.

The term “image” used throughout the specification may be used as a comprehensive term for describing various forms of video image information, such as a “picture”, “frame”, “field” or “slice”, which may be known in the related field, as well as the term “image” itself. For example, an “image” may mean one of a plurality of pictures or a plurality of frames constructing video content, and may mean the entire of video content including a plurality of pictures or a plurality of frames.

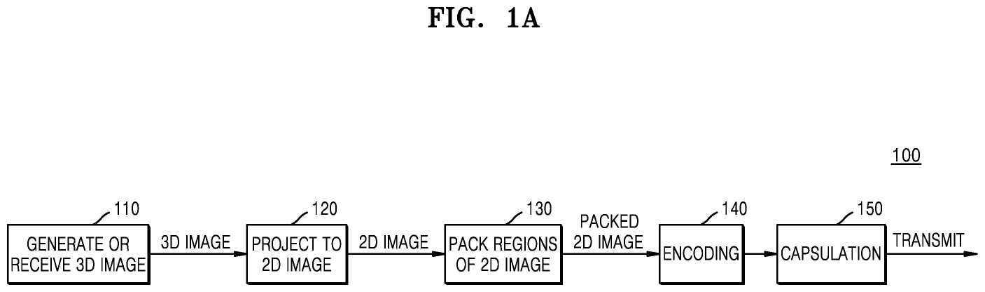

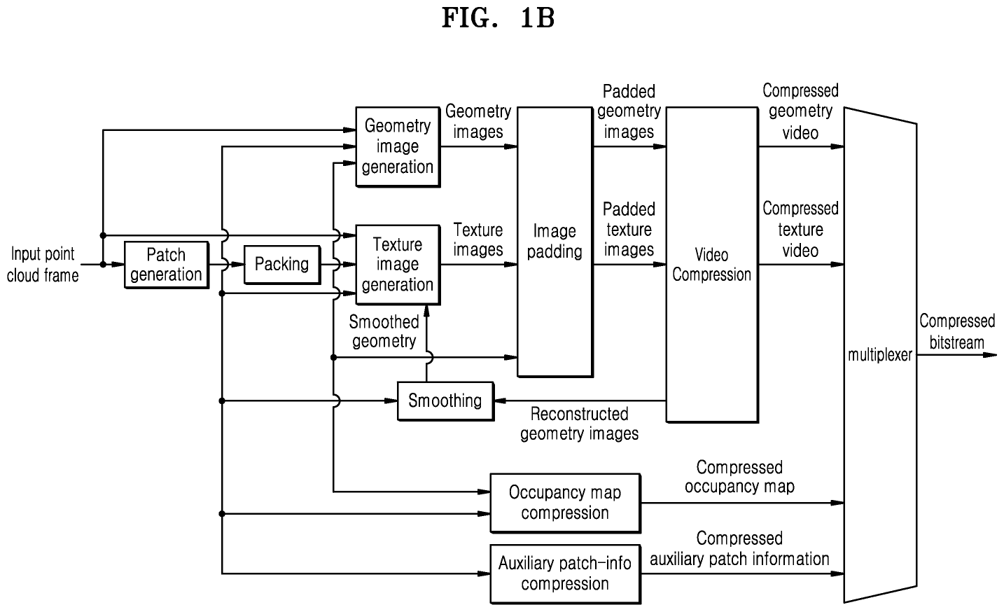

FIG. 1A illustrates a general data process of a transmitter for transmitting data about a 3D image, according to an embodiment of the disclosure.

For example, the transmitter according to an embodiment may be a server for providing data or a service related to a 3D image. The 3D image may indicate both a dynamic image and a static image. Also, the data about the 3D image may include immersive media data including 360 degree omnidirectional virtual reality content or 6 degree-of-freedom related content.

In operation 110 of FIG. 1A, a transmitter 100 may obtain a 3D image. As an example, the transmitter 100 may stitch images photographed in several directions by a plurality of cameras to generate a 3D image. As another example, the transmitter 100 may receive information about a previously generated 3D image from outside. For example, a 3D image may be rendered to a form of a sphere, a cube, a cylinder, or an octahedron. However, in the disclosure, the form of a 3D image is not limited to the above-described examples, and various forms of 3D images may be generated or received.

In operation 120, the transmitter 100 may project the 3D image in a space on a 2D plane to generate a 2D image. The transmitter 100 according to an embodiment may project an omnidirectional image in a 3D space on a square picture having a predefined format.

To project a 3D image to a 2D image, any one of equirectangular projection (ERP), octahedron projection (OHP), cylinder projection, cube projection, and various projections which are usable in the related technical field may be used.

In operation 130, the transmitter 100 may pack the projected 2D image. Packing may mean changing a location, size, and direction of at least a part of a plurality of regions constructing a projected 2D image to generate a new 2D image (that is, a packed 2D image). For example, for packing, resizing, transforming, rotating and/or re-sampling (for example, up-sampling, down-sampling, or differential sampling according to locations in a region) of a region, etc. may be performed.

The transmitter 100 according to an embodiment of the disclosure may perform region-wise packing on the projected 2D image. During the region-wise packing, the transmitter 100 may change locations, sizes, and directions of the regions constructing the projected 2D image. Also, the transmitter 100 may process a configuration of a picture to be used for user viewpoint-based processing by raising total compression efficiency or increasing resolution of a region corresponding to a specific viewport rather than those of the other regions, thereby generating a packed picture.

FIG. 1B illustrates a structure of a video based point cloud compression (V-PCC) encoder.

A V-PCC encoder, which is an embodiment of the transmitter 100, may start from projecting input 3D point cloud data on a 2D space to generate a patch, and the patch generated in the 2D space may be classified into a geometry image including location information and a texture image including color information and generated. A process of generating a patch may include a process of determining a bounding box of a point cloud for each frame and projecting points being closet to surfaces of a hexahedron constructing the bounding box in the form of orthogonal projection to generate a patch.

Also, auxiliary patch information of each patch, such as projective plane information, a patch size, etc., required for decoding, may be generated, and an occupancy map may be generated by representing whether a point exists for each pixel as a binary map while packing generated patches on a 2D plane. The occupancy map may be used to distinguish pixels corresponding to a patch from pixels not corresponding to a patch in a region of each image.

The generated auxiliary patch information and occupancy map may be compressed by using entropy coding, and the geometry image and the texture image may be subject to video compression by using an existing video codec. Because a patch image is represented as a video image, any kind of video codecs may be used. However, in moving picture experts group (MPEG), a high efficiency video coding (HEVC) standard is used as a formal video codec standard.

When a little loss does not greatly influence the image quality of media, as in remote chatting, games, etc., 3D V-PCC may compress geometry information and attributes differently from the original or omit compressing geometry information and attributes. In this case, lossy compression may be performed.

Meanwhile, to implement maximum quality of original data, a goal of lossless compression may be to maintain the same number of points as that of the original while maximally maintaining data precision of the original. In this case, near lossless compression of setting, when a floating point is input, a preset range of tolerance values and allowing errors within the preset range of tolerance values may also be considered as lossless compression.

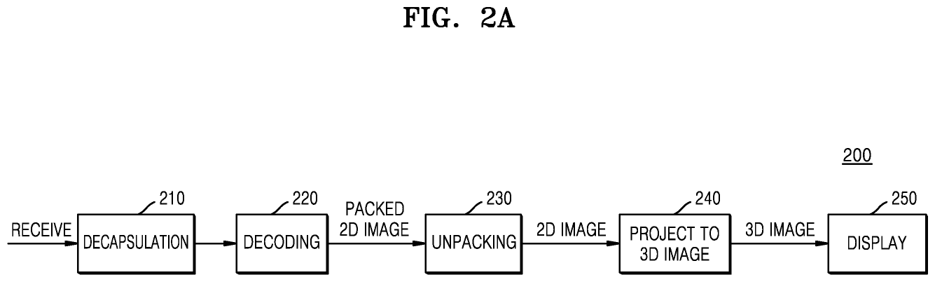

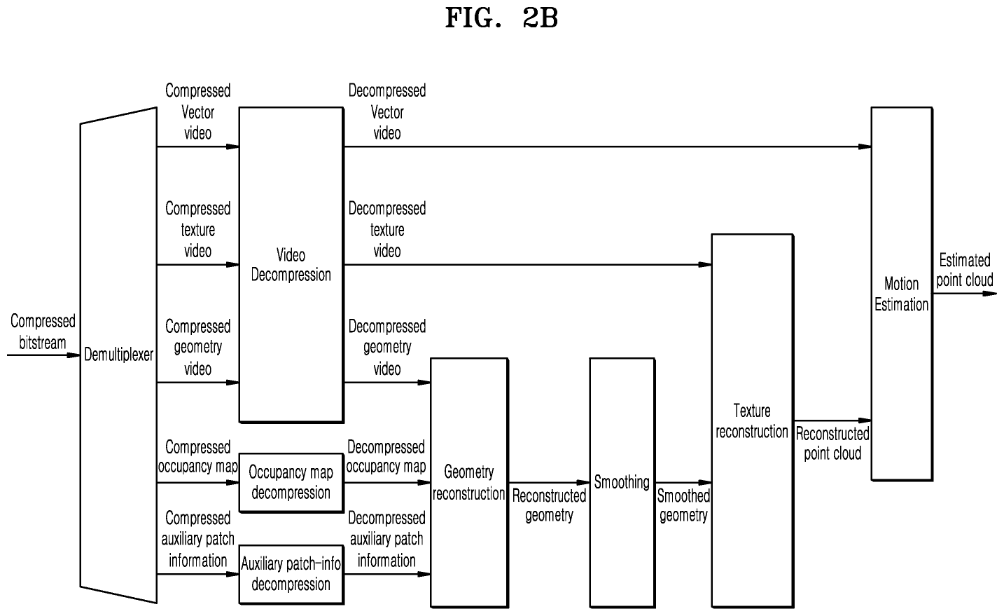

FIG. 2A illustrates a general data process of a receiver for receiving data about a 3D image, according to an embodiment of the disclosure.

A receiver 200 according to an embodiment of the disclosure may be an augmented reality (AR) device that is capable of providing AR content to users, or a virtual reality (VR) device that is capable of providing VR content to users. Also, the receiver 200 may indicate all kinds of devices that are capable of receiving data about 3D images to reproduce the 3D images.

The receiver 200 according to an embodiment of the disclosure may receive data about a 3D image transmitted from the transmitter 100. In operation 210 of FIG. 2A, the receiver 200 may perform decapsulation on the received data. Through the decapsulation of operation 210, encoded data generated through encoding of operation 140 in FIG. 1A may be obtained.

In operation 220, the receiver 200 may perform decoding on the decapsulated data. Through the decoding of operation 220, a packed 2D image may be reconstructed.

The receiver 200 may perform image rendering on the decoded data to display a 3D image. More specifically, in operation 230, the receiver 200 may perform unpacking on the decoded data (that is, the packed 2D image). Through the unpacking of operation 230, the 2D image generated through projection of operation 120 in FIG. 1A may be reconstructed.

To perform unpacking, the receiver 200 may perform inverse-transformation of modification and/or rearrangement on the plurality of regions of the 2D image projected in packing of operation 130 in FIG. 1A. To perform inverse-transformation, the receiver 200 may have known a packing method of the data, performed by the transmitter 100. For example, the packing method may have been known in advance between the transmitter 100 and the receiver 200. For example, the transmitter 100 may transfer information about a packing method to the receiver 200 through a separate message such as metadata. As another example, information about a packing method may be included in a header of transmission data generated through capsulation, and transferred to the receiver 200.

In operation 240, the receiver 200 may project the unpacked 2D image to a 3D image. The receiver 200 according to an embodiment may use inverse-projection of projection used in operation 120 of FIG. 1A to project the 2D image to the 3D image, although not limited thereto. The receiver 200 may generate the 3D image by projecting the unpacked 2D image to the 3D image.

In operation 250, the receiver 200 may display at least a part of the 3D image generated in operation 240 through a display. For example, the receiver 200 may extract only data corresponding to a current field of view (FOV) from the 3D image, and render the extracted data.

FIG. 2B illustrates a structure of a V-PCC decoder.

A V-PCC decoder which is an embodiment of the receiver 200 may decode an encoded geometry image by using an existing video codec, and reconfigure geometry information of 3D point cloud data through an occupancy map and auxiliary patch information. Also, the V-PCC decoder may decode an encoded texture image to finally reconfigure point cloud data.

V-PCC may support a method of changing a Level of Detail (LoD) which is a density between points in a 3D space by dividing geometry information of 3D point cloud data by an integer, as well as supporting changing an existing video codec-based quantization parameter (QP), in order to support content having various qualities.

A quantization coefficient which is a quality parameter presumed in V-PCC may adjust precision of 3D point cloud content, and a LoD may adjust the number of absolute points of 3D point cloud content.

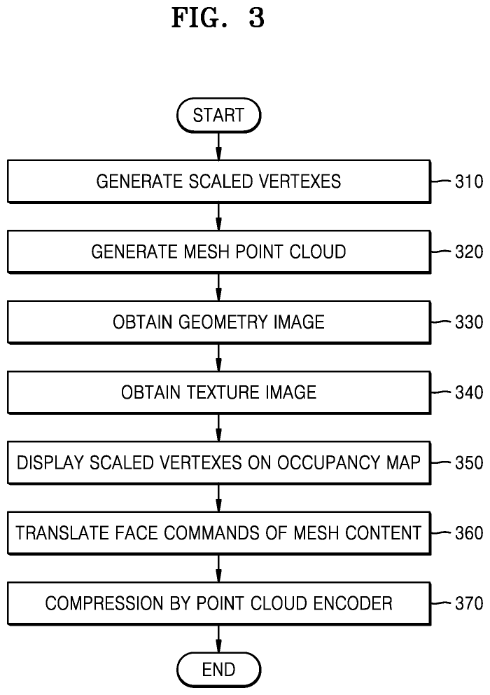

FIG. 3 is a flowchart illustrating a method of compressing mesh content by using V-PCC, according to an embodiment of the disclosure.

As described above, in a V-PCC process, 3D content represented as a point cloud may be projected on a 2D plane. V-PCC may include a process of projecting each region of 3D content on an optimal 2D plane according to contours of the 3D content to obtain 2D plane patches and classifying the patches into a geometry image and a texture image to pack the patches.

Also, V-PCC may include a process of generating an occupancy map including information about whether points exist at preset locations on a 3D space and compressing a geometry image, a texture image, and the occupancy map by using a 2D video encoder.

Mesh content may include information about vertexes, information about faces including triangular planes connecting the vertexes, and texture information being color information padding the faces, in order to represent an object on a 3D space.

When mesh content is compressed by using V-PCC, vertexes of the mesh content may correspond to points of a point cloud. However, in point cloud data, spaces between points may be padded with points, whereas mesh content generates lines or faces by connecting vertexes of figures based on face commands.

V-PCC may group adjoined points included in a point cloud as connected components and then project the connected components on a 2D plane to generate a patch which is a region having a width. Accordingly, when V-PCC is performed by using vertexes of mesh content as they are, a desired patch cannot be obtained, and also, points not included in connected components may be processed as missed points, resulting in a reduction of compression efficiency.

Accordingly, to compress mesh content by using V-PCC, a process of changing mesh content to a form for V-PCC may be needed.

Referring to FIG. 3, a method of compressing mesh content may include the following operations.

A method of compressing mesh content, according to an embodiment of the disclosure, may scale vertexes of mesh content based on a scale factor to generate scaled vertexes, in operation 310.

According to an embodiment, a process of scaling vertexes may be scaling down intervals between the vertexes by an arbitrary magnification. According to an embodiment, the scale factor may be determined to be a lossless scale factor causing mesh content to be reconstructed without missing information about vertexes, upon reconstructing of the mesh content by a decoder.

The method of compressing the mesh content, according to an embodiment of the disclosure, may include operation 320 of generating a mesh point cloud based on the scaled vertexes.

According to an embodiment, the mesh point cloud may be generated by a process of padding spaces between the scaled vertexes with points. According to an embodiment, the mesh point cloud may be generated by a process of padding spaces between the scaled vertexes with points to enable a 2D video encoder to perform most efficient compression, based on compression efficiency. A method of padding spaces between scaled vertexes with points will be described in detail, later.

The method of compressing the mesh content, according to an embodiment of the disclosure, may include operation 330 of obtaining a geometry image based on the mesh point cloud.

A V-PCC encoder may generate a patch from the mesh point cloud and pack the generated patch to generate a geometry image for V-PCC compression.

The method of compressing the mesh content, according to an embodiment of the disclosure, may include operation 340 of obtaining a texture image having a form that can be subject to V-PCC encoding based on texture information of the mesh content.

Operation of processing texture information of mesh content to a form that can be subject to V-PCC encoding may have various configurations according to functions of an encoder and a decoder that process texture information. Various configurations that process texture information of mesh content to a form that can be subject to V-PCC encoding will be described later.

The method of compressing the mesh content, according to an embodiment of the disclosure, may include operation 350 of displaying the scaled vertexes of the mesh content on an occupancy map.

According to an embodiment, points corresponding to vertexes may be distinguished from padded points in mesh point cloud data based on information about the scaled vertexes.

The method of compressing the mesh content, according to an embodiment of the disclosure, may include operation 360 of translating face commands of the mesh content based on the occupancy map. Translating the face commands of the mesh content based on the occupancy map may mean representing the face commands based on a bitmap of the occupancy map. For example, locations of vertexes may be determined with reference to the occupancy map, and vertex information may be signaled through face commands connecting the individual vertexes by a decoder. The signaled vertex information may be used to reconstruct V-PCC compressed mesh content.

The method of compressing the mesh content, according to an embodiment of the disclosure, may include operation 370 of compressing the geometry image, the texture image, the occupancy map, and the translated face commands of the mesh point cloud by a V-PCC encoder.

Hereinafter, each operation will be described in more detail with reference to the drawings.

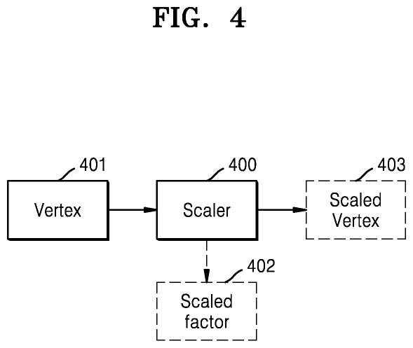

FIG. 4 is a view for describing a process of calculating a scaled vertex and a scale factor, according to an embodiment of the disclosure.

Referring to FIG. 4, a scaler 400 may obtain a scale factor 402 by using vertex information 401, and obtain scaled vertex information 403 based on the vertex information 401 and the scale factor 402.

According to an embodiment, the scale factor 402 may be determined to be a value causing mesh content to be reconstructed without missing information about vertexes, and the scaler 400 may scale down an interval between the vertexes by an arbitrary magnification determined by the scale factor 402 to generate a scaled vertex, thereby obtaining the scaled vertex information 403. According to an embodiment, the scale factor 402 may have a 3D direction. In this case, the mesh content may be scaled down with non-equidistant intervals in the 3D direction.

The interval between the vertexes, scaled down by applying the scale factor 402, may be reconstructed by using the scale factor 402.

According to an embodiment of the disclosure, the scale factor 402 may be determined by the following method.

SYNTAX 1
scale_factor[origin, factor, operation, flag_lossless]
origin = [x,y,z]
factor = [x,y,z]
operation / /0=subtract, 1=divide
flag_lossless / /0=lossy, 1=lossless
/ /example
scale_factor[ [0, 0, 0], [1, 3, 2], 0, 0]

Origin means an origin, and factor means a factor that is applied to each step of calculating a scale factor. After origin[x,y,z] is determined, coordinate values of a vertex may be divided or subtracted by factor[x,y,z] toward the origin[x,y,z]. Operation is a value representing whether to divide or subtract the coordinate values by factor[x,y,z]. When a value of operation is 0, the coordinates of the origin may be subtracted by a scale factor, and, when the value of operation is 1, the coordinates of the origin may be divided by the scale factor.

Whether a result value after operation can be reconstructed to a value before operation in each step may be denoted as flag_lossless. Also, a factor may be applied several times in the order in which it is written. The order in which the factor is applied upon reconstruction may be the reverse order. When the application order of the factor is not kept, reconstructed vertex information may become different from the original.

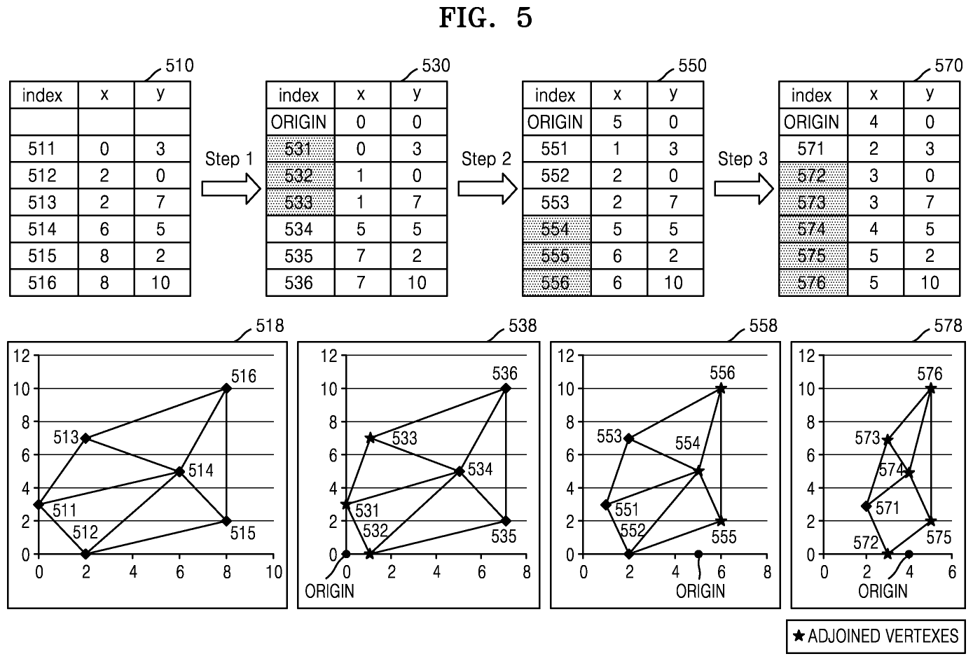

FIG. 5 is a view for describing a vertex scaling process according to an embodiment of the disclosure.

Referring to FIG. 5, vertexes may be adjoined through a scaling process performed several times.

SYNTAX 2
scale_factor [ [0, 0, 0], [1, 0, 0], 0, 1] / /step1
scale_factor [ [5, 0, 0], [1, 0, 0], 0, 1] / /step21
scale_factor [ [4, 0, 0], [1, 0, 0], 0, 1] / /step3

A process of applying scale factors written in syntax 2 in order to scale vertexes is illustrated in FIG. 5. For convenience of description and drawing, a x-y plane of z=0 is illustrated, and a case in which scaling is performed by 1 only in an x-axis direction is illustrated.

510 represents coordinates of vertexes 511 to 516 before scaling.

Step 1 may be lossless scaling corresponding to substract, Flag_loss=1, because of scale_factor[[0,0,0],[1,0,0],0,1] and operation=1. Because the origin is [0,0,0] and a scale factor is [1,0,0], coordinates of vertexes 531 to 536 scaled by step 1 may become locations moved by 1 toward the origin x=0 from the coordinates of the vertexes 511 to 516 before scaling. 530 represents the coordinates of the vertexes 531 to 536 scaled through step 1, and 538 shows the coordinates of the vertexes 531 to 536 on an orthogonal coordinates system. In 538, vertexes adjoined with 531 corresponding to the origin x=0 may become 532 and 533 having a difference of 1 on the x axis from 531.

Step 2 may be lossless scaling corresponding to substract, Flag_loss=1, because of scale_factor[[5,0,0],[1,0,0],0,1] and operation=1. Because the origin is [5,0,0] and a scale factor is [1,0,0], coordinates of vertexes 551 to 556 scaled by step 2 may become locations moved by 1 toward the origin x=5 from the coordinates of the vertexes 531 to 536 before scaling. 550 represents the coordinates of the vertexes 551 to 556 scaled through step 2, and 558 shows the coordinates of the vertexes 551 to 556 on the orthogonal coordinates system. In 558, vertexes adjoined with 554 corresponding to the origin x=5 may become 555 and 556 having a difference of 1 on the x axis from 554.

Step 3 may be lossless scaling corresponding to substract, Flag_loss=1, because scale_factor[[4,0,0],[1,0,0],0,1] and operation=1. Because the origin is [4,0,0] and a scale factor is [1,0,0], coordinates of vertexes 571 to 576 scaled by step 3 may become locations moved by 1 toward the origin x=4 from the coordinates of the vertexes 551 to 556 before scaling. 570 represents the coordinates of the vertexes 571 to 576 scaled through step 3, and 578 shows the coordinates of the vertexes 571 to 576 on the orthogonal coordinates system. In 578, vertexes adjoined with 574 corresponding to the origin x=4 may become 572, 573, 575, and 576 having a difference of 1 on the x axis from 574.

The reason of applying a scale factor may be to scale down intervals between vertexes. Referring to FIG. 5, it is seen that intervals between vertexes are reduced through scale-down performed three times, and the vertexes are adjoined with each other.

According to an embodiment of the disclosure, operation of determining a scale factor may include operation of determining a scale factor to be a lossless scale factor causing a reconstructed vertex to be identical to its original vertex upon reconstructing of a scaled vertex.

However, when a scaled vertex is generated with respect to an original vertex, the scaled vertex is compressed by using V-PCC and then reconstructed, and the reconstructed vertex is different from the original vertex, a loss may be generated.

Because vertexes have an irregular distribution according to content, scale factors may depend on content. A time at which a lossless scale factor is obtained may be a time at which, when vertexes are divided or subtracted by a scale factor for mesh content configured with original vertexes while increasing the scale factor from 1 with respect to one of x, y, and z axes, the vertexes are adjoined. A scale factor [x, y, z] obtained by performing the above-described process with respect to three axes may be a lossless scale factor vector.

According to an embodiment of the disclosure, operation of determining, as a scale factor, a lossy scale factor being reconstructable within a preset error range in consideration of compression efficiency may be included.

According to an embodiment of the disclosure, a method of calculating a lossy scale factor being reconstructable within a preset error range in consideration of efficiency may be used. Also, according to an embodiment of the disclosure, a scale factor that cannot completely reconstruct original vertexes may be calculated although a loss is generated. According to a method of using a lossy scale factor, because a smaller number of vertexes than original vertexes are reconstructed, the restored vertexes may be not identical to the original vertexes. According to an embodiment of the disclosure, whether to apply a lossy scale factor may be determined in consideration of compression capacity or subjective image quality.

According to an embodiment of the disclosure, whether a scale factor is a lossy scale factor or a lossless scale factor may have been determined in advance in system level, and a device of scaling mesh content may determine whether vertex information has been missed based on information about whether a scale factor is a lossy scale factor or a lossless scale factor.

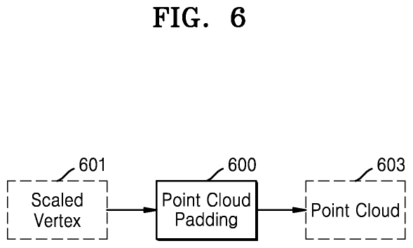

FIG. 6 is a view for describing a process of transforming scaled vertexes to a mesh point cloud for V-PCC.

As shown in FIG. 6, mesh content may be transformed to a mesh point cloud 603 by padding (600) a space between scaled vertexes 601 with a point cloud for processing in V-PCC.

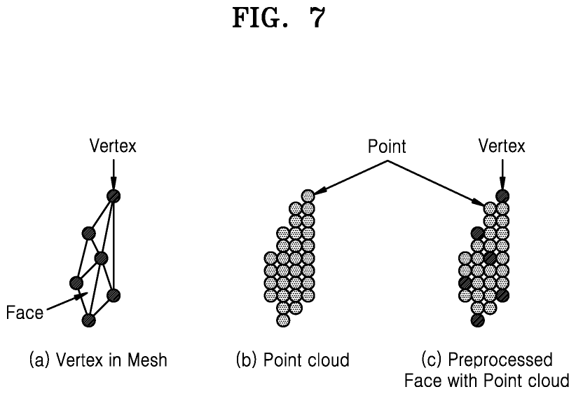

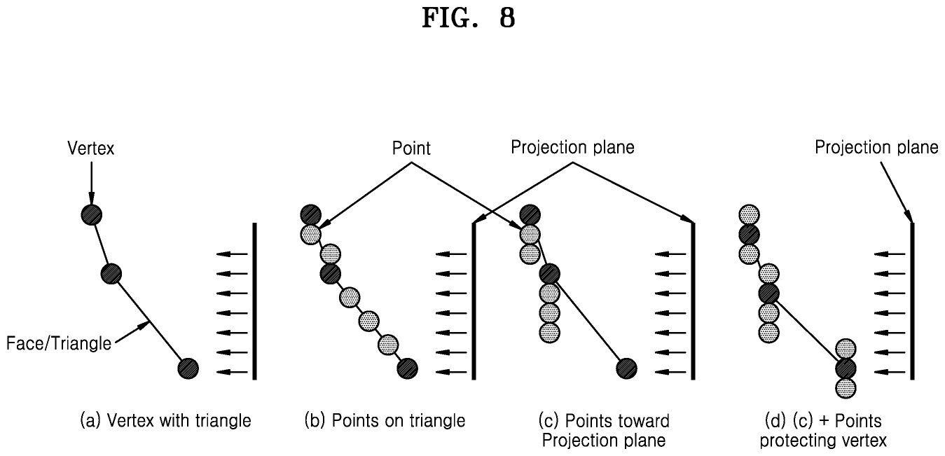

FIGS. 7 and 8 are views for describing a process of padding a space between scaled vertexes with points, according to an embodiment of the disclosure.

FIG. 7 is a view for describing a process of transforming mesh content to a mesh point cloud by using scaled vertex information of the mesh content, according to an embodiment of the disclosure.

As illustrated in part (a) of FIG. 7, scaled vertex information on a 3D space may include only information about vertexes, and there may be no shape that can be considered as a face. Meanwhile, as illustrated in part (b) of FIG. 7, in point cloud data, points may have been quantized to a shape that can be processed as a face, or may be processed as a face after quantization.

According to an embodiment of the disclosure, mesh content having scaled vertex information may generate mesh point cloud data by padding a space between scaled vertexes with points for V-PCC processing. As shown in part (c) of FIG. 7, in mesh point cloud data, vertex information constructing mesh content and triangle information may have been translated to points. Therefore, the mesh point cloud data may be processed by using V-PCC.

FIG. 8 is a view for describing a process of padding points by quantizing mesh content representing a 3D object, according to an embodiment of the disclosure.

A method of compressing mesh content, according to an embodiment of the disclosure, may include operation of padding a space between scaled vertexes with points by reflecting triangle information.

As illustrated in part (a) of FIG. 8, mesh content may be configured with vertex information and face commands based on triangle information connecting vertexes. Therefore, according to an embodiment of the disclosure, to transform mesh content to a mesh content cloud allowing V-PCC, as illustrated in part (b) of FIG. 8, an empty space between vertexes may be processed to exist on a line segment connecting the vertexes or a face of a triangle.

According to an embodiment of the disclosure, coordinates that the line segment connecting the vertexes or the face of the triangle passes may be quantized, and points may be arranged at most appropriate locations. Also, by anti-aliasing the coordinates that the line segment connecting the vertexes or the face of the triangle passes, points may be arranged on two or more appropriate locations.

According to an embodiment of the disclosure, a method of compressing mesh content may include operation of padding points in consideration of V-PCC compression. For example, the method of compressing mesh content may include operation of padding points such that a 2D video encoder has highest compression efficiency.

V-PCC may include operation of selecting one of 6 faces of a bounding box surrounding a 3D object and projecting 3D data on the corresponding plane. Therefore, according to an embodiment of the disclosure, as illustrated in part (c) of FIG. 8, the space between the vertexes may be padded in such a way to be orthogonal to one projection plane selected from among 6 faces of a bounding box.

A 2D video encoder has a feature of being vulnerable to errors on surfaces of discontinuity of colors. According to another embodiment of the disclosure, as illustrated in part (d) of FIG. 8, upper and lower spaces of each vertex may be padded with points being at the same distance from the vertex as possible based on distances between the vertexes when seen from the projection plane. In this case, the feature that the 2D video encoder is vulnerable to errors on surfaces of discontinuity of colors may be compensated.

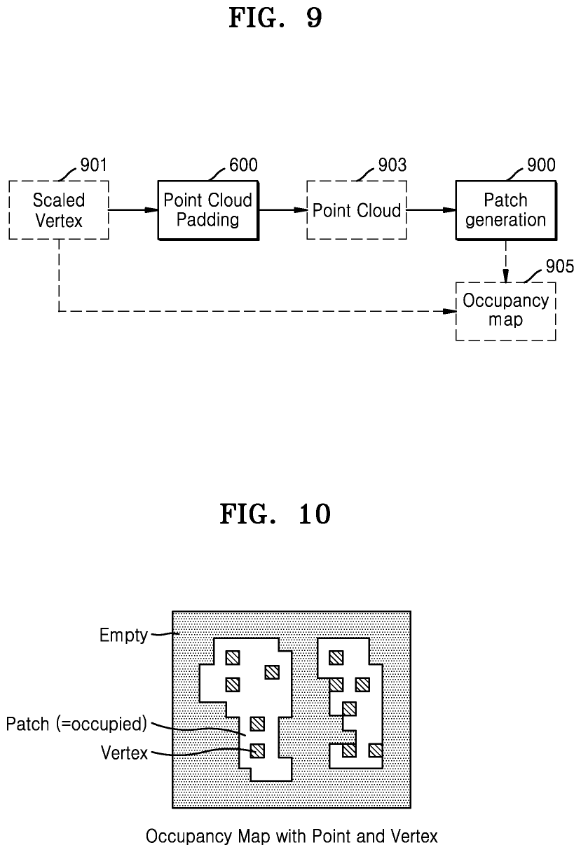

FIGS. 9 and 10 are views for describing a process of displaying scaled vertexes on an occupancy map, according to an embodiment of the disclosure.

FIG. 9 is a view for describing a process of displaying scaled vertexes of mesh content on an occupancy map, according to an embodiment of the disclosure.

As illustrated in FIG. 9, mesh content may pad (600), for processing in V-PCC, a space between scaled vertexes 901 with a point cloud to obtain mesh point cloud data 903, obtain (900) a 2D patch from the mesh point cloud data 903, and then display the scaled vertexes 901 separately on an occupancy map 905.

To reconstruct mesh content after encoding and decoding of point cloud data by using V-PCC, a process of identifying which ones of reconstructed points are points corresponding to vertexes and which ones of the reconstructed points are points for padding may be needed.

According to an embodiment of the disclosure, by displaying the scaled vertexes 901 separately on the occupancy map 905, points corresponding to the vertexes may be distinguished from padded points by using the occupancy map.

FIG. 10 illustrates an occupancy map displaying points for 2D patches of mesh point cloud data, according to an embodiment of the disclosure.

As shown in FIG. 10, in patches displayed on an occupancy map, points corresponding to vertexes may be distinguished and displayed from other points or empty spaces.

According to an embodiment of the disclosure, when a padded point on an occupancy map is displayed as 1, a point corresponding to a vertex may be displayed as 2. However, a method for distinguishing an empty space, a padded point, or a vertex is not limited to the above-described method, and various methods may be applied.

According to an embodiment of the disclosure, it may be preferable to indicate vertexes without loss and compress an occupancy map without loss by setting precision of the occupancy map to 1.

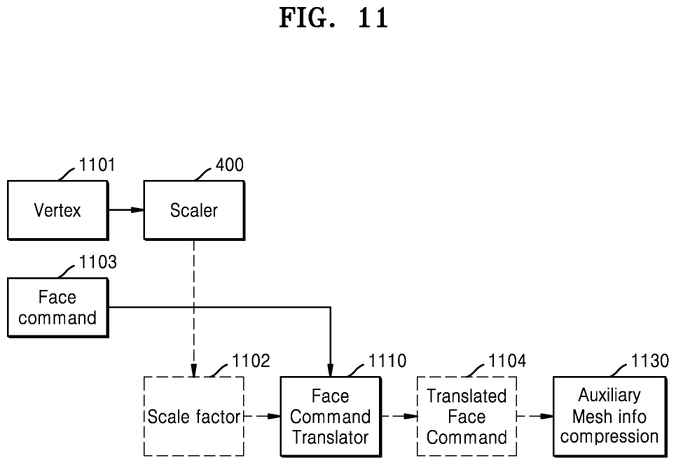

FIG. 11 is a view for describing a process of representing face commands about vertexes based on a bitmap of an occupancy map, according to an embodiment of the disclosure.

As described above, scaled vertex information included in mesh point cloud data may be compressed and decoded by using V-PCC. However, mesh point cloud data may include, as shown in FIG. 7, triangle (face) information which existing point cloud data does not include. Therefore, to process triangle information by using V-PCC, separate processing for face commands may be needed.

For example, locations of vertexes may be determined with reference to an occupancy map, and vertex information may be signaled by a decoder through face commands connecting the vertexes. The signaled vertex information may be used to reconstruct V-PCC compressed mesh content.

Referring to FIG. 11, a scale factor 1102 may be obtained based on vertex information 1101 of mesh content, and face commands 1103 connecting vertexes of the mesh content may be translated (1110) to a V-PCC compressible form based on the scale factor 1102. Translated face commands 1104 may be compressed (1130) to auxiliary mesh information of a mesh point cloud.

Hereinafter, a method of connecting vertexes in mesh content will be described in detail.

syntax 3

f 2302 2303 2304

According to an embodiment of the disclosure, a face command represented by syntax 3 may define a polygon (for example, a line, a triangle, a rectangle, etc.) connecting a 2302^{nd} vertex, a 2303^{rd} vertex, and a 2304^{th} vertex of mesh content. V-PCC may not preserve the order of points. Accordingly, because vertexes and the other points are mixed and input to V-PCC in random order, there may be a problem that face commands cannot be applied directly to reconstruct a decoded mesh point cloud to mesh content.

According to an embodiment of the disclosure, because vertexes are displayed separately on an occupancy map, mapping information about what number of an original vertex in original mesh content has been scaled to a scaled vertex and assigned to which patch may need to be managed upon encoding of V-PCC.

After mapping is performed, information about faces may be stored by a method in which face commands indicate vertexes, based on an arrangement of the vertexes on the occupancy map.

An embodiment of a method of indicating vertexes based on an arrangement of vertexes in an occupancy map may be as follows.

It may be assumed that first coordinates of an occupancy map is a first entry of a serialized bitstream. In this case, a vertex being at a location (x, y) in the occupancy map having a size w*h of width w and height h may be represented as y*w+x. A face command indicating the vertex may be represented as syntax below.

SYNTAX 4
f {bit offset of vertex #2302} {bit offset of vertex #2303}
{bit offset of vertex #2304}
/ /#2302 at 4000, #2303 at 4100, #2304 at 4200
f 4000 4100 4200

According to another embodiment of the disclosure, a vertex may be represented as a bit offset in a patch of an occupancy map. When a patch has a size of width u0 and length v0, a bit offset of a vertex being at a location (x, y) may be represented as u0*y+x.

According to another embodiment of the disclosure, vertexes may be represented in an order of the vertexes in a patch of an occupancy map. Generally, because a triangle exists within a relationship between neighboring vertexes, specifying what number of vertex in a patch may be preferable. In this case, a face command may be represented as syntax below.

SYNTAX 5
f {patch ID} {vertex ID1} {vertex ID2} {vertex ID3}
f p:30 1 2 3 / / first, second and third vertex in Patch 30

A face command connecting a vertex existing within a patch to a vertex existing within another patch, when vertexes are represented in an order of the vertexes in patches, may be represented as syntax below.

SYNTAX 6
f p:30 1 2 p:31 1 / / Face command connecting vertexes 1 and 2
of 30^{th} patch to vertex 1 of 31^{st} patch

Syntax for representing information about faces of mesh content as a bitstream may be as follows.

SYNTAX 7
unsigned int(2) type / / face,patch,vertex,reserved
if (type != 0): / / 0=face
if (type == 1): / / 1=patch
utf8 patch_id
elif (type == 2): / / 2=vertex
utf8 vertex_id
0 1 30 2 1 2 2 2 3 / /f p:30 1 2 3
00b 01b 1Eh 10b 01h 10b 02h 10b 03h
0 1 30 2 1 2 2 1 31 2 1000 / /f p:30 1 2 p:31 1
00b 01b 1Eh 10b 01h 10b 02h 01b 1Fh 10b CFA8h

According to an embodiment of the disclosure, a method of compressing mesh content may include operation (not shown) of applying texture information of the mesh content to a 2D video encoder of V-PCC.

Because color attributes of a point cloud exist on a 3D space, in V-PCC, a geometry image generated by projecting point cloud data on a projection plane and a texture image may have the same form of patches.

According to an embodiment of the disclosure, a V-PCC encoder may use a method of using, upon compression of mesh content, texture information of the mesh content as it is, signaling the texture information, and informing a V-PCC decoder not to reconstruct color information by a method of reconstructing color information about a mesh point cloud.

Because texture information of mesh content exists on a 2D plane, a process of fixing texture information of mesh content to a 2D plane through separate projection may be not needed.

However, when texture information of mesh content is input with respect to a 2D video encoder of V-PCC, signaling for informing that content is a mesh form or that the texture information is texture of a mesh, not texture of a patch, such that the texture information is not reconstructed as a shape of a patch upon decoding, may be needed.

According to an embodiment of the disclosure, the corresponding signaling may be provided as patch auxiliary information or auxiliary mesh information.

According to another embodiment of the disclosure, a method of arranging texture information of a mesh on a 3D space consisting of unscaled vertexes, patching the texture information by using V-PCC, then reconstructing scaled vertexes by using a scale factor in a V-PCC decoder, and again scaling the scaled vertexes to forms used in the mesh may be used.

According to another embodiment of the disclosure, a method of mapping mesh texture to color attributes of point cloud data described above, compressing a result of the mapping by using V-PCC, and then reconstructing a result of the compressing in a decode may be suggested.

According to an embodiment of the disclosure, a lossy compression method may be used in a process of compressing texture information of a mesh.

According to another embodiment of the disclosure, a method of scaling down mesh texture and then compressing the mesh texture or compressing the mesh texture by adjusting a quantization parameter, instead of compressing the mesh texture with its original size, may be suggested.

A method of compressing mesh content, according to an embodiment of the disclosure, may include operation of compressing auxiliary mesh information including a geometry image, a texture image, an occupancy map, and face commands of a mesh point cloud by using V-PCC.

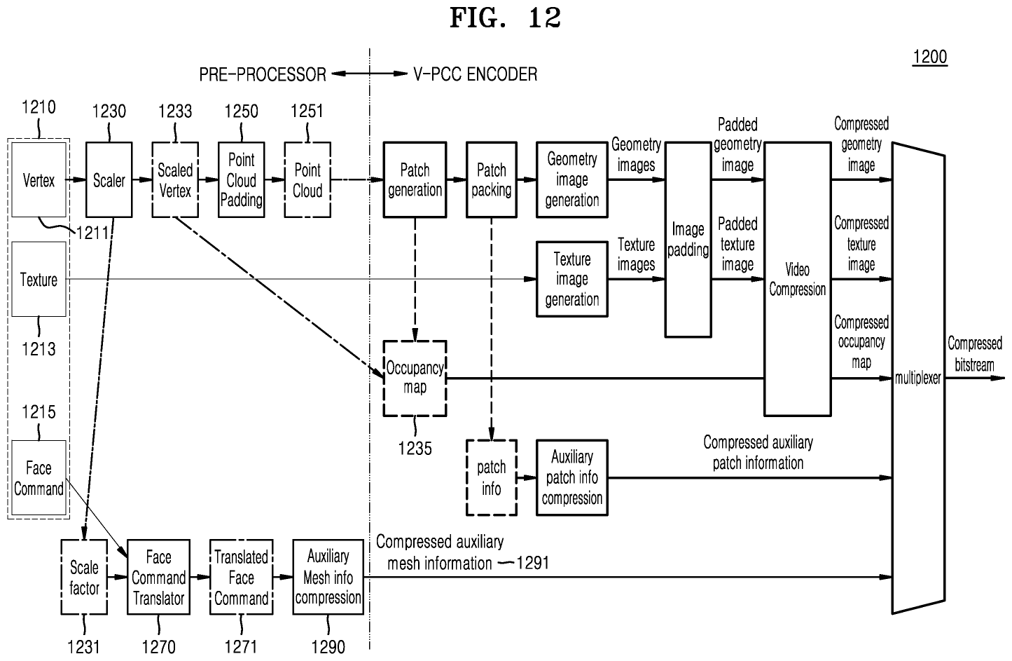

FIG. 12 illustrates an architecture of a device of compressing mesh content by using V-PCC, according to an embodiment of the disclosure.

Referring to FIG. 12, a device 1200 of compressing mesh content by using V-PCC, according to an embodiment of the disclosure, may be configured with a pre-processor for transforming mesh content 1210 to mesh point cloud data, and a V-PCC encoder.

In FIG. 12, mesh content and pre-processed mesh content may be indicated by different lines, and the pre-processed mesh content may be applied to the V-PCC encoder and compressed.

The pre-processor for transforming mesh content to mesh point cloud data may include a vertex scaler 1230 for scaling vertexes of the mesh content 1210, a mesh point cloud generator 1250 for padding spaces between the scaled vertexes with points to generate a mesh point cloud, a face command translator 1270 for translating face commands of the mesh content 1210 to a form that can be subject to V-PCC encoding, and a compressor 1290 for compressing the translated face commands to auxiliary mesh information.

Individual components of the pre-processor of the device 1200 of compressing mesh content by using V-PCC, according to an embodiment of the disclosure, may be implemented as a software module. The individual components of the pre-processor of the device 1200 of compressing mesh content by using V-PCC, according to an embodiment of the disclosure, may be implemented by using a hardware module or a software module included in V-PCC.

The mesh content 1210 for representing a 3D object which is an input of the device 1200 of compressing mesh content may include vertex information 1211, texture information 1213, and face commands 1215 of each frame.

By scaling vertexes 1211 of mesh content to scaled vertexes 1233 by the vertex scaler 1230 and padding spaces between the scaled vertexes 1233 with points by the mesh point cloud generator 1250, a mesh point cloud 1251 may be generated. Thereafter, a V-PCC encoder may generate a patch from the mesh point cloud 1251, and pack the generated patch to generate a geometry image for the mesh point cloud.

The vertex scaler 1230 may calculate a final scale factor 1231 based on used factors, while scaling the vertexes 1211 of the mesh content 1210. The final scale factor 1231 may be used to transform the texture information 1213 of the mesh content 1210.

The texture information 1213 of the mesh content 1210 may be video-compressed to a texture image for compressing the mesh point cloud.

According to an embodiment of the disclosure, because the texture information 1213 of the mesh content 1210 exists on a 2D plane, the texture information 1213 of the mesh content 1210 may be compressed to the texture image of the mesh point cloud without having to perform separate projection. In this case, an encoder may need to separately signal a signal informing of texture of mesh content such that a decoder can reconstruct the texture information 1213 as mesh content.

According to an embodiment of the disclosure, the texture information 1213 of the mesh content 1210 may be arranged on a 3D space configured with unscaled vertexes and patched, thereby being V-PCC compressed. In this case, the texture information 1213 of the mesh content 1210 may be mapped to color attributes of point cloud data and compressed.

The device 1200 of compressing mesh content by using V-PCC, according to an embodiment of the disclosure, may use an occupancy map 1235 to distinguish the scaled vertexes 1233 from among points configuring mesh cloud points.

The occupancy map 1235 may be video-compressed, like geometry images and texture images. By signaling the occupancy map 1235 on which the scaled vertexes 1233 are displayed separately by a decoder, an order of vertexes in a mesh point cloud reconstructed by the decoder may be obtained, and the reconstructed mesh point cloud may be reconstructed to the mesh content 1210.

The face commands 1215 of the mesh content 1210 may be translated based on a scale factor by the face command translator 1270, and translated face commands 1271 may be compressed to auxiliary mesh information 1291 by the compressor 1290.

The video-compressed geometry image, the video-compressed texture image, the occupancy map, entropy-compressed auxiliary patch information, and entropy-compressed auxiliary mesh information may be transformed to a bitstream through a multiplexer and then transmitted.

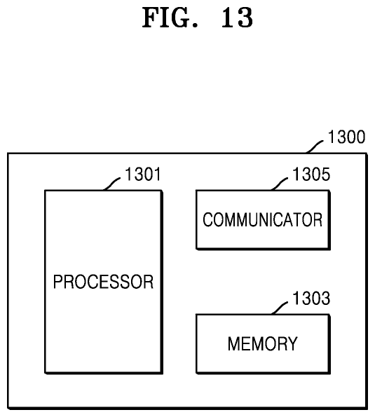

FIG. 13 is a block diagram of a device of compressing mesh content, according to an embodiment of the disclosure.

Referring to FIG. 13, a device 1300 of compressing mesh content, according to an embodiment of the disclosure, may include a processor 1310, a communicator 1320, and a memory 1330.

The device 1300 of compressing mesh content, according to an embodiment of the disclosure, may be implemented as a pre-processor of an encoder or a part of an encoder, and FIG. 13 shows only components related to an embodiment. Accordingly, it will be understood by those of ordinary skill in the art that other general-purpose components can be further included in addition to the components shown in FIG. 13.

The processor 1310 may control a series of processes for compressing mesh content, described above with reference to FIG. 1 to 12.

Also, the processor 1310 may control overall functions for controlling the device 1300 of compressing mesh content. For example, the processor 1310 may execute programs stored in the memory 1330 included in the device 1300 for compressing mesh content, thereby controlling overall operations of the device 1300 of compressing mesh content. The processor 1310 may be implemented as a central processing unit (CPU), a graphics processing unit (GPU), an application processor (AP), etc., included in the device 1300 of compressing mesh content, although not limited thereto.

The communicator 1320 may connect the device 1300 of compressing mesh content to another device or module to receive and transmit data by using a communication module such as a wired/wireless local area network (LAN).

The memory 1330 may be hardware storing various data processed in the device 1300 of compressing mesh content, and the memory 1330 may store, for example, data received by the communicator 1320 and data processed by the processor 1301 or to be processed by the processor 1301.

The memory 1330 may include random access memory (RAM), such as dynamic random access memory (DRAM), static random access memory (SRAM), etc., read-only memory (ROM), electrically erasable programmable read-only memory (EEPROM), compact-disc read only memory (CD-ROM), Blueray or another optical disc storage, a hard disk drive (HDD), a solid state drive (SSD), or a flash memory.

The methods according to the embodiments of the disclosure described in claims or specification thereof may be implemented in the form of hardware, software, or a combination of hardware and software.

When the methods are implemented in software, a computer-readable storage medium or a computer program product storing at least one program (software module) may be provided. The at least one program stored in the computer-readable storage medium or the computer program product may be configured for execution by at least one processor within an electronic device. The at least one program may include instructions that cause the electronic device to execute the methods according to the embodiments of the disclosure described in the claims or specification thereof.

The program (software module or software) may be stored in RAM, a non-volatile memory including a flash memory, ROM, electrically erasable programmable read only memory (EEPROM), a magnetic disc storage device, CD-ROM, digital versatile discs (DVDs) or other types of optical storage devices, or a magnetic cassette. Alternatively, the program may be stored in a memory that is configured as a combination of some or all of the memories. A plurality of such memories may be included.

Furthermore, the program may be stored in an attachable storage device that may be accessed through communication networks such as the Internet, Intranet, a local area network (LAN), a wide LAN (WLAN), or a storage area network (SAN), or a communication network configured in a combination thereof. The storage device may access a device performing the embodiments of the disclosure through an external port. Further, a separate storage device on the communication network may also access the device performing the embodiments of the disclosure.

In the disclosure, the terms “computer program product” or “computer-readable medium” may be used to collectively indicate a memory, a hard disk installed in a hard disk drive, and a medium such as a signal. The terms “computer program product” or “computer-readable medium” may be means for providing a computer system with software configured with commands for setting a length of a timer for receiving missed data packets, based on a network metric corresponding to a determined event according to the disclosure.

The computer-readable storage media may be provided in a form of non-transitory storage media. Herein, the ‘non-transitory storage media’ means that the storage media do not include a signal (for example, an electromagnetic wave) and are tangible, without meaning that data is semi-permanently or temporarily stored in the storage media. For example, the ‘non-transitory storage media’ may include a buffer in which data is temporarily stored.

According to an embodiment, the methods according to various embodiments disclosed in the present specification may be included in a computer program product and provided. The computer program product may be traded as a product between a seller and a purchaser. The computer program product may be distributed in the form of a machine-readable storage medium (e.g., CD-ROM), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to the embodiments of the disclosure as described above, components included in the disclosure may include a single entity or multiple entities. The expression single or plural has been selected appropriately according to situations provided for convenience of description, and the disclosure is not limited to a single or plurality of components. That is, a plurality of components may be integrated into a single component, or a single component may be divided into a plurality of components.

Meanwhile, although detailed embodiments have been described in the detailed description of the disclosure, various modifications are possible without deviating from the scope of the disclosure. Therefore, the scope of the present disclosure should not be limited to the described embodiments and should be defined by the claims described below and equivalents thereof.

1. A method of compressing mesh content representing a 3-dimensional (3D) object,
the mesh content including vertex information about a plurality of vertexes of the 3D object, a face command about a face formed by connecting the vertexes, and texture information about a color of the face,
the method comprising:
obtaining a scale factor and generating a plurality of scaled vertexes by changing an interval between the vertexes,
generating a mesh point cloud by padding a space between the scaled vertexes with points,
obtaining a geometry image from the mesh point cloud,
obtaining a texture image based on the texture information,
displaying the scaled vertexes on an occupancy map,
translating the face command based on at least one of the scale factor or the occupancy map, and
generating a bitstream by compressing the geometry image, the texture image, the occupancy map, and the translated face command with a video-based point cloud compression (V-PCC) encoder.

2. The method of claim 1, wherein the generating of the plurality of scaled vertexes comprises scaling down the vertexes representing the 3D object with respect to an origin.

3. The method of claim 2, wherein the scaling down of the vertexes is repeated until the scaled-down vertexes are adjoined with each other.

4. The method of claim 1, wherein the translated face command is included in auxiliary mesh information.

5. The method of claim 1,
wherein the geometry image and the texture image are compressed with high efficiency video coding (HEVC), and
wherein the translated face command is entropy-compressed.

6. The method of claim 1, wherein the translating of the face command is based on locations of the scaled vertexes on the occupancy map.

7. The method of claim 1, further comprising generating a bitstream including information representing that the texture image is texture of mesh content.

8. The method of claim 1, wherein the obtaining of the texture image comprises:
arranging the texture information in a 3D space configured with the vertexes; and
patching the arranged texture information based on V-PCC.

9. A device for compressing mesh content representing a 3-dimensional (3D) object,
the mesh content including vertex information about a plurality of vertexes of the 3D object, a face command about a face formed by connecting the vertexes, and texture information about a color of the face,
the device comprising:
a memory,
a communicator, and
at least one processor,
wherein the at least one processor is configured to:
obtain a scale factor and generate a plurality of scaled vertexes by changing an interval between the vertexes,
generate a mesh point cloud by padding a space between the scaled vertexes with points,
obtain a geometry image from the mesh point cloud,
obtain a texture image based on the texture information,
display the scaled vertexes on an occupancy map,
translate the face command based on at least one of the scale factor or the occupancy map, and
generate a bitstream by compressing the geometry image, the texture image, the occupancy map, and the translated face command with a video based point cloud compression (V-PCC) encoder.

10. The device of claim 9, wherein the at least one processor is further configured to obtain the scaled vertexes by scaling down the vertexes representing the 3D object with respect to an origin.

11. The device of claim 10, wherein the at least one processor is further configured to repeat the scaling down of the vertexes until the scaled-down vertexes are adjoined with each other.

12. The device of claim 9, wherein the translated face command is included in auxiliary mesh information.

13. The device of claim 9, wherein the at least one processor is further configured to compress the geometry image and the texture image with high efficiency video coding (HEVC), and entropy-compress the translated face command.

14. The device of claim 9, wherein the at least one processor is further configured to translate the face command based on locations of the scaled vertexes on the occupancy map.

15. The device of claim 9, wherein the at least one processor is further configured to generate a bitstream including information representing that the texture image is texture of mesh content.

16. The device of claim 9, wherein the at least one processor is further configured to arrange the texture information on a 3D space configured with the vertexes, and patch the arranged texture information based on V-PCC to obtain the texture image.

17. A computer-readable recording medium having recorded thereon a computer program for executing the method according to claim 1.
